(19) United States
(12) Patent Application Publication
(10) Pub. No.: US 2015/0050531 A1
(43) Pub. Date: Feb. 19, 2015

(54) BATTERY CELL CONNECTOR

(71) Applicants: Erik Felser, Erbach (DE); Joachim Rief, Biberach (DE); Tobias Zeller, Neu-Ulm (DE)

(72) Inventors: Erik Felser, Erbach (DE); Joachim Rief, Biberach (DE); Tobias Zeller, Neu-Ulm (DE)

(73) Assignee: HUSQVARNA AB, Huskvarna (SE)

(21) Appl. No.: 14/381,825

(22) PCT Filed: Mar. 5, 2012
(86) PCT No.: PCT/EP2012/053727

§ 371 Date: Aug. 28, 2014

(51) Int. Cl. H01M 2/34; H01M 2/20

(52) U.S. Cl. CPC H01M 2/34; H01M 2/204; H01M 2220/30; H01M 2200/00
USPC 429/61; 29/623.1

(57) ABSTRACT

A battery system includes a connector electrically connecting, in parallel, three or more battery cells, where the connector includes a fuse integrally formed therein at least between a first one or more cells in the group of cells and a second one or more cells in the group of cells. The connector may be a unitary piece of conductive material that has a cross sectional area that narrows between each cell to form a fuse between each of the three or more battery cells and/or narrows between pairs of the three or more battery cells. Each fuse's cross-sectional area is dimensioned so as to disconnect the cell(s) on one side of the fuse from the cell(s) on the other side of the fuse, thereby preventing a thermal runaway event. A battery pack comprising this battery system may have an external fuse that responds to a short circuit occurring external to the battery system before the connector's fuses do. Likewise, the connector's fuses may respond to a short circuit occurring within the battery system before the external fuse does. The connector may facilitate an improved method of manufacturing battery packs.

### TECHNICAL FIELD

Example embodiments generally relate to battery pack technology.

### BACKGROUND

Property maintenance tasks are commonly performed using various tools and/or machines that are configured for the performance of corresponding specific tasks. Certain tasks, like cutting trees, trimming vegetation, blowing debris and the like, are typically performed by hand-held tools or power equipment. The hand-held power equipment may often be powered by gas or electric motors. Until the advent of battery powered electric tools, gas powered motors were often preferred by operators that desired, or required, a great deal of mobility. Accordingly, many walk-behind or ride-on outdoor power equipment devices, such as lawn mowers, are often powered by gas motors because they are typically required to operate over a relatively large range. However, as battery technology continues to improve, the robustness of battery powered equipment has also improved and such devices have increased in popularity.

The batteries employed in hand-held power equipment may, in some cases, be removable and/or rechargeable assemblies of a plurality of smaller cells that are arranged together in series and/or parallel arrangements in order to achieve desired output characteristics. However, when these cells are arranged together to form battery packs, it is important to consider that different cells may have different characteristics that could impact interactions between the cells. For example, if one cell begins to deteriorate or fail, it may reach full charge before other cells and then be exposed to high temperature and/or pressure stresses while other cells continue to charge. Furthermore, if one cell in a parallel group of cells fails (e.g., short circuits), other cells may begin to discharge at a high rate through the failed cell, which may again cause large thermal and/or pressure stresses that could result in damage to the battery pack.

To avoid damage to battery packs, it may be important to consider employing design features that can either prevent or reduce the likelihood of the early onset of failure for one or a group of cells, or otherwise provide safety mechanisms to mitigate or prevent damage when such a failure occurs.

### BRIEF SUMMARY OF SOME EXAMPLES

In order to provide a battery system that addresses the above issues and/or other issues, a cell connector is provided that connects a group of three or more battery cells together in parallel, where the cell connector comprises a unitary conductor having at least one fuse integrally formed therein such that at least one fuse is located electrically between a first battery cell and a plurality of other battery cells in the group of three or more battery cells. In some embodiments, the unitary conductor comprises at least two fuses integrally formed therein such that at least one fuse is located electrically between each battery cell in the group of three or more battery cells. In other embodiments, the group of three or more battery cells comprises at least four battery cells, and the at least one fuse located electrically between the first battery cell and the plurality of other battery cells is located electrically between a first plurality of cells (comprising the first battery cell) and a second plurality of cells. In some embodiments, the unitary conductor comprises a single piece of metallic material.

In some embodiments, the at least one fuse comprises a fuse portion and the unitary conductor comprises a first body portion comprising a first cross-sectional area, and a second body portion comprising a second cross-sectional area. In such an embodiment, the fuse portion may be disposed between the first and second body portions and comprise a third cross-sectional area which is less than the first cross-sectional area and less than the second cross-sectional area, the third cross-sectional area being dimensioned so as to disconnect the first body portion from the second body portion when a current traveling to or form one of the group of three of more battery cells reaches a threshold. In some such embodiments, the first body portion is connected to a first one or more battery cells and the second body portion is connected to a second one or more battery cells such that when the fuse portion disconnects the first body portion from the second body portion, the first one or more battery cells are electrically disconnected from the second one or more battery cells. In some such embodiments, the second body portion is further connected to a load such that when the fuse disconnects the first and second body portions, the second one or more battery cells remains electrically connected with the load.

In some embodiments, the unitary conductor comprises three or more pad portions corresponding with the three or more battery cells such that each pad portion is fastened to a terminal of one battery cell in the group of three or more battery cells. The unitary conductor may also comprise a central portion electrically coupled to a common battery terminal. The unitary conductor may further comprise three or more fuse portions integrally formed with the central portion and the three or more pad portions, wherein each of the three or more fuse portions is located between one of the three or more pad portions and the central portion and comprises a smaller cross section than the pad portions and the central portion so as to form fuses located electrically between each battery cell in the group of three or more battery cells. In some such embodiments, each of the three or more fuse portions is located proximate to a different pad portion so that each fuse disconnects only the battery cell attached to the respective pad. In some such embodiments, the three or more battery cells comprises a first pair of cells and a second pair of cells, and the central portion comprises a first fuse between the first pair of cells and the second pair of cells so that when the first fuse is broken the first pair of cells are electrically disconnected from the second pair of cells.

In some embodiments of the battery system the three or more battery cells comprises a first pair of cells, a second pair of cells, and a third pair of cells. In such embodiments, the at least one fuse may comprise a first fuse disposed between the first and second pairs of cells so as to disconnect the first pair of cells from the second set of cells when the first fuse is broken, and a second fuse disposed between the third pair of cells and the second pairs of cells so as to disconnect the first and second pair of cells from the third set of cells when the second fuse is broken.

Some embodiments of the battery system also include an external fuse disposed between a common battery terminal and the central portion. In some embodiments of the battery system, the unitary conductor comprises a plate that has a uniform thickness, and wherein only the width of the unitary conductor narrows to reduce a cross-sectional area of the at least one fuse.

Embodiments of the invention also provide a cell connector configured for attachment to a plurality of battery cells, where the cell connector comprises: (i) a body; (ii) a first pad configured to connect to a first battery cell of the plurality of battery cells to the body; (iii) a second pad configured to connect to a second battery cell of the plurality of battery cells to the body; (iii) a third pad configured to connect to a third battery cell of the plurality of battery cells to the body; and (iv) a first fuse portion being shaped and dimensioned to break down when the first battery cell outputs a defined amount of current, thereby disconnecting the first battery cell from at least one other battery cell. In some such embodiments, the cell connector further comprises: (v) a second fuse portion being shaped and dimensioned to break down when the second battery cell outputs a defined amount of current, thereby disconnecting the second battery cell from at least one other battery cell; and (vi) a third fuse portion being shaped and dimensioned to break down when the third battery cell outputs a defined amount of current, thereby disconnecting the third battery cell from at least one other battery cell. In some such embodiments, the body, the first pad, the second pad, the third pad, the first fuse portion, the second fuse portion, and the third fuse portion are integrally formed as a single piece of conductive material.

In some embodiments of the cell connector, the first fuse portion is configured to disconnect only the first battery cell from the other battery cells and any load connected to the cell connector, the second fuse portion is configured to disconnect only the second battery cell from the other battery cells and any load connected to the cell connector, and the third fuse portion is configured to disconnect only the third battery cell from the other battery cells and any load connected to the cell connector.

In some embodiments of the cell connector, a fourth pad is configured to connect to a fourth battery cell of the plurality of battery cells to the body. In some such embodiments, the first fuse portion is shaped and dimensioned to break down when either the first battery cell or the fourth battery cell outputs a defined amount of current, thereby disconnecting the first battery cell and the fourth battery cell from the second battery cell and the third battery cell.

Embodiments of the invention also provide a method of manufacturing a battery pack where a plurality of cells are to be connected in parallel and each of the plurality of cells is to be connected to a common output via a current path. In some embodiments the method includes: (i) providing a group of three or more battery cells; (ii) providing a connector, the connector electrically connecting the group of three of more battery cells together in parallel, the connector comprising a unitary conductor comprising at least two fuses integrally formed therein such that at least one fuse is located electrically between at least two battery cells in the group of three or more battery cells, wherein the connector defines the current path between the common output and each of the battery cells, and wherein the connector comprises a conductor arranged in a structure configured to electrically couple to the common output at a first end portion and to a terminal of each of the plurality of cells at each of a plurality of second end portions; (iii) positioning the connector proximate the group of three or more battery cells so that each of the plurality of second end portions aligns with a terminal of a cell; and (iv) fastening each of the plurality of second end portions to the terminal with which it aligns to facilitate parallel connection of the plurality of cells within the battery pack. In some embodiments, providing the connector comprises forming a single, unitary metallic conductor.

Some example embodiments allow for a battery cell to be electrically disconnected from a battery system if one of the battery cells experiences thermal runaway. This protects the battery cells and the load that the battery pack is connected to.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1A illustrates a perspective view of a plurality of connected cells in a battery pack according to an embodiment;

FIG. 1B illustrates a top view of the cells of FIG. 1A;

FIG. 2 illustrates a perspective view of a plurality of cells in a battery system including a cell connector having fuses according to an example embodiment of the present invention;

FIG. 3 illustrates a top view of the cells and exemplary cell connector of FIG. 2;

FIG. 4A illustrates a top view of a portion of the exemplary cell connector of FIG. 2;

FIG. 4B illustrates a side view of a portion of the exemplary cell connector illustrated in FIG. 4A;

FIG. 4C illustrates a side view of a portion of an exemplary cell connector according to another embodiment;

FIG. 5 illustrates a method of protecting a battery system from thermal runaway according to some embodiments;

FIG. 6A illustrates a top view of a portion of the cell connector of FIG. 2;

FIG. 6B illustrates a top view of the portion of the cell connector of FIG. 6A with the fuse being broken according to an embodiment;

FIG. 7A illustrates a top view of the battery system of FIG. 2 with an illustration of current flow according to an embodiment;

FIG. 7B illustrates a top view of the battery system of FIG. 2 with a fuse proximate to a battery cell being broken according to an embodiment;

FIG. 7C illustrates a top view of the battery system of FIG. 2 including an illustration of a centerline fuse for a pair of battery cells being broken according to an embodiment;

FIG. 8 illustrates a method of manufacturing a battery pack according to some embodiments of the invention;

FIG. 9 illustrates a top view of the cells and exemplary cell connector according to some embodiments; and

FIG. 10 illustrates a top view of the cells and exemplary cell connector according to some embodiments.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

In an example embodiment, a cell connector is used to electrically connect a plurality of battery cells together to form at least a portion of a battery pack. The cell connector connects a node of each of at least three cells in parallel and, in some embodiments, is shaped so that a portion of the cell connector functions as a fuse for each cell (an “internal” fuse). In this regard, when one or more battery cells deteriorate, a high amount of current is disposed on one of the internal fuses, which causes this fuse to electrically disconnect the improperly-operating cell(s) from the other cell(s) in the battery system.

The battery system employing the cell connector disclosed herein may be utilized in any battery pack or battery-powered device. In some embodiments, the battery system may be employed in outdoor power equipment to provide electrical energy to components of the outdoor power equipment. For example, embodiments of a battery pack and/or cell connector described herein may be used to provide electrical power to various components of such outdoor power equipment as string trimmers, chainsaws, clippers, lawn care vehicles, robotic mowers, and/or any other device which uses a battery system.

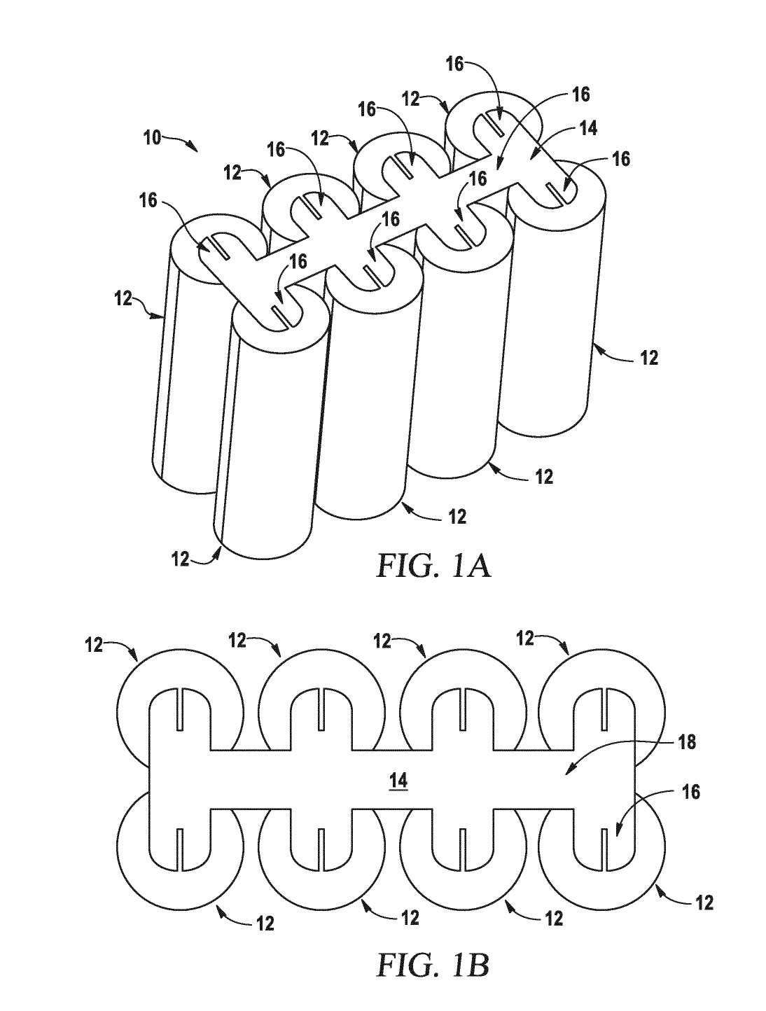

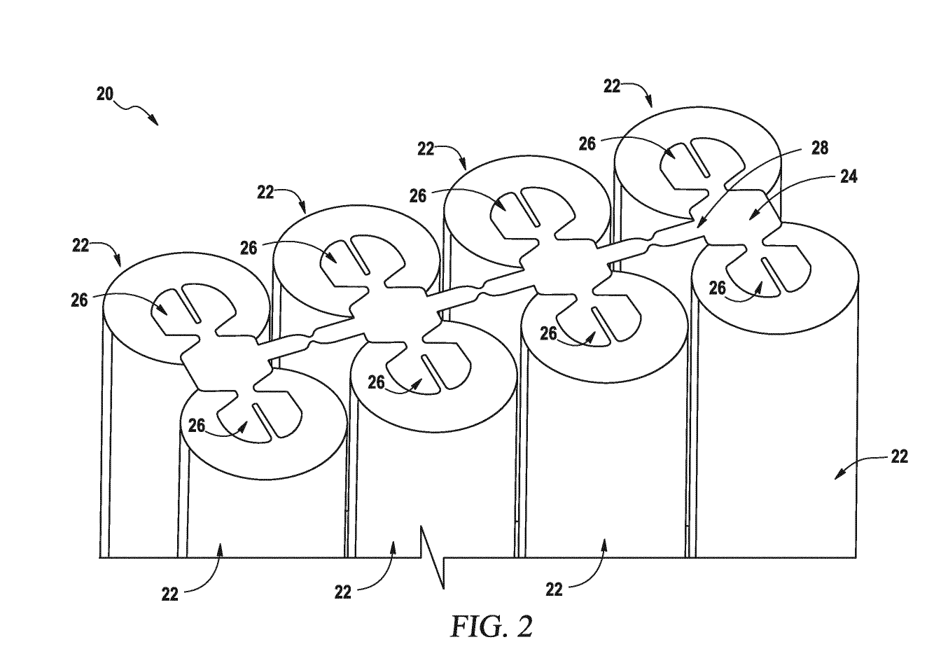

FIG. 1, which includes FIGS. 1A and 1B, illustrates an example of a battery system 10, which includes a plurality of battery cells 12 and a battery connector 14. Each of the cells 12 may be any suitable type of battery cell. For example, the cells 12 may be nickel-metal hydride, nickel-cadmium, lithium-ion, or other similar cells. In some cases, nominal cell voltages may range from about 1V to about 4V. The battery connector 14 connects the positive terminals of each of the battery cells 12 so that all of the cells are electrically connected together in parallel. In some embodiments, each of the battery cells 12 comprises a plurality of cells connected in series. In other words, in some embodiments the battery connector 14 connects groups of series-connected cells in parallel as opposed to individual cells. The battery connector 14 has a pad 16 that may be welded, soldered, bolted, or otherwise electrically attached to the positive terminals of each of the battery cells 12. In the illustrated embodiment, the battery connector 14 is a unitary conductor, such as single unitary piece of metal (e.g., steel, nickel, copper, various alloys, etc.), and allows for a connection to a load (not shown).

Each battery cell 12 transmits power from the positive terminal of a battery cell 12 to pad 16 of the cell connector 14 and the power then may be transmitted to a common central portion 18 of the cell connector 14 which acts as a common node for the battery cells 12. In this regard, the battery cells 12 are connected to each other in parallel. The common central portion 18 can then be connected to a load.

It will be appreciated that, although not shown, a connector identical or similar to connector 14 may be used on the underside of the battery system 10 to connect the negative terminals of cells 12. In this way, the two connectors 14 connecting the positive and negative terminals of the cells 12 connect the cells 12 in parallel to form a group of electrically connected cells. This group of cells may then be connected to a common battery pack terminal, a printed circuit board for the battery pack, and/or a load by itself or along with still other groups of cells connected to this group in series or in parallel.

In certain situations, an “external” fuse (not shown), which may be located between the battery system 10 and a load (e.g., between the battery system and one of the battery pack terminals), may protect the battery pack and the battery cells 12 contained therein in the event of short circuits occurring in circuits that are external to the battery system 10 (e.g., circuits in the battery-powered device). For example, the external fuse may be connected between the battery pack 10 and the load so that the battery pack 10 may be disconnected or open-circuited with the load. This protects both the battery pack 10 and the load from any external short circuits. However, the external fuse will not protect the battery pack 10 from thermal runaway caused by internal short circuits, overloading or mechanical damaging. Further, if one battery cell 12 is damaged or thermally unstable, such cell 12 will impact the other cells and the thermal runaway cannot be stopped. To address the above issues, the battery system 20 described with reference to FIGS. 2 through 8 has internal fuses built into a connector 24 that connects a group of three or more cells 22 in parallel. Despite the internal fuses in this battery system 20, an external fuse (not shown) may still be used to protect against short circuits external to the battery system 20. In such embodiments, this external fuse may be configured to react to an external short circuit faster than the internal fuses in the connector 24 do, and the internal fuses in the connector 24 may be configured to react to an internal defect faster than the external fuse does.

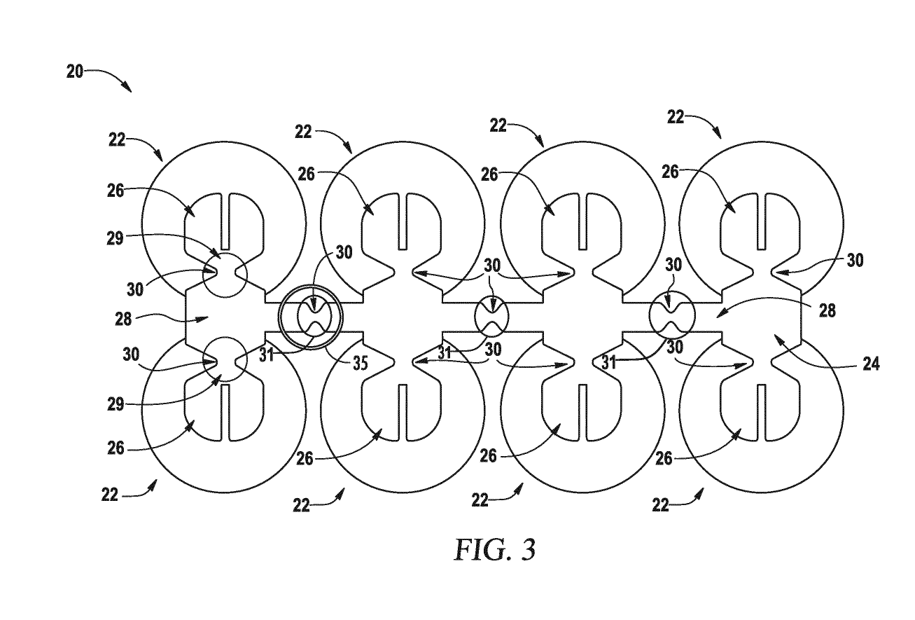

FIGS. 2 and 3 illustrate perspective and top views, respectively, of a battery system 20 including a cell connector 24 according to an example embodiment of the present invention. The cell connector 24 connects any number of battery cells 22 in parallel according to one embodiment. For example, as illustrated in FIGS. 2-3, eight battery cells 22 may be connected together in parallel. The cells 22 may be nickel-metal hydride, nickel-cadmium, lithium-ion, or other any other suitable type of battery cell of any voltage. In some cases, nominal cell voltages of each cell are in the range of about 1V to about 4V. As with the battery system 10 described with respect to FIG. 1, the cells 22 in this battery system 20 may be individual cells or each comprise a plurality of cells connected in series. In other words, in some embodiments the battery connector 24 connects groups of series-connected cells in parallel as opposed to individual cells. According to some embodiments, the cell connector 24 is composed of a material which has an internal resistance, such as steel, nickel, aluminum, copper, zinc, various alloys, other metals, and/or metal plating or any combination thereof.

The cell connector 24 includes a central body portion 28 and a plurality of pads 26. The number of pads 26 included on the cell connector 24 is equal to the amount of battery cells 22 included in the battery system 20. Each pad 26 is connected to a positive terminal of each respective battery cell 22 by welds (e.g., spot welds), solder joints, bolts, fasteners, adhesives, integral formation, and/or any other coupling method. In one embodiment, each pad 26 is welded to each respective battery cell terminal. Such connection allows each battery cell 22 to transfer electrical power from the battery cells 22 to the cell connector 24 and vice versa.

As with FIG. 1, only one side (the positive side) of the battery system 20 and cells 22 is shown. It will be appreciated that, to complete the parallel connection, the negative terminals on the underside of the cells 22 in the illustrated battery system 20 may also be connected in parallel via a connector similar or identical to connector 24. Alternatively, since connector 24 already includes fuses formed therein the negative terminals may be connected together using a connector 14 like the one illustrated in FIG. 1. Similarly, the connector 24 with the fuses may connect the negative terminals of the cells 22 and the positive terminals may then be connected with a fuse-less connector 14 like the one illustrated in FIG. 1. In another embodiment, the negative terminals may simply each be connected to a ground (either a common ground or separate grounding nodes).

According to some embodiments, the cell connector 24 is a single unitary piece of metal (or other conductive material) such that the central body portion 28 and the pads 26 are integrally formed together. For example, as illustrated in the exemplary embodiments of FIGS. 2 and 3, the cell connector 24 may be formed from a single piece of metal (e.g., steel), whereby the steel piece is shaped to form pads 26 and narrowing portions (fuses 30).

As illustrated in FIGS. 3, 9 and 10, the cell connector 24 includes portions that have a narrowing cross-section. These portions are referred to herein as fuses 30 and are configured to burn out when a certain amount of current flows therethrough for too great an amount of time. The fuses 30 can be arranged in various configurations as will now be discussed with reference to FIGS. 3, 9 and 10. As illustrated, in some embodiments of the invention, the connector 24 is formed so that a fuse 30 is at a position 29 located between each of the battery cells 22 so that each cell can be electrically isolated from the rest of the cells if it has a defect and supplies or draws too much current. In particular, the connector 24 illustrated in of FIG. 3 is formed so that a fuse 30 is at a position 29 located between each pad 26 and the central body portion 28 and also at position 31 in the central body portion 28 between each pair of cells 22 (“between” meaning electrically between, not necessarily physically between). This can be repeated for the rest of the cells 22 as illustrated in FIG. 3 (although the positions 29 are not explicitly shown on each set of cells for purpose of clarity). This arrangement is particularly useful when the cells are arranged in a parallel arrangement as each cell would be removed from the circuit when the fuse is burnt out.

As mentioned above and as illustrated in FIG. 3, some embodiments of the connector 24 have fuses 30 at position 31 located between groups of cells (e.g., between each pair of cells) so that at least some groups of cells can be electrically isolated from others in the event that a particular group of cells has one or more defects that combine to cause the group to supply or draw too much current. Placement of the fuses 30 at position 31 is used when the cells 22 are used in a serial arrangement, according to some embodiments.

There are different configurations of fuses at positions 29 and 31, which are each discussed below.

In some embodiments, as illustrated in FIG. 3, fuses 30 are located at both positions 29 and 31 for each cell or pair of cells so that the pairs of cells are isolatable and each cell 22 individually is isolatable. In some embodiments, there are fuses 30 located at some of positions 29 and 31 but there may not be a fuse at every position of 29 or 31 so that there is at least one fuse between two pairs of cells 22 (position 31) and at least one fuse 30 between the pad 26 and the central body portion 28 (position 29).

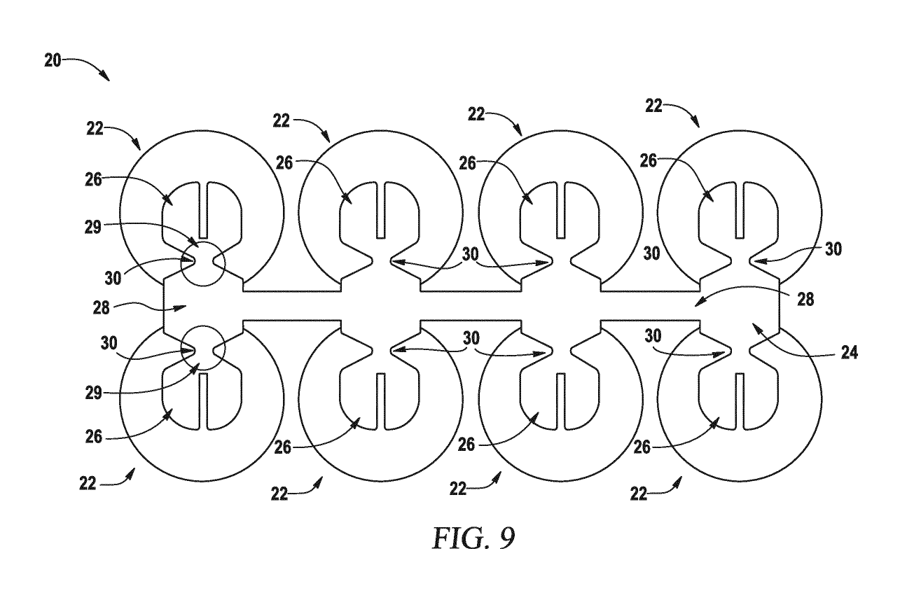

According to some other embodiments, the fuses 30 may only be at positions between the pads 26 and the central body portion 28 (as illustrated by positions 29 in FIG. 9), and thus the fuses may not be located at other areas on the connector 24, as illustrated in FIG. 9. In these embodiments, fuses 30 are only located at position 29 proximate to one or more cells 22 so that there are not any fuses 30 at position 31 along the central body portion 28 between any of the pair of cells.

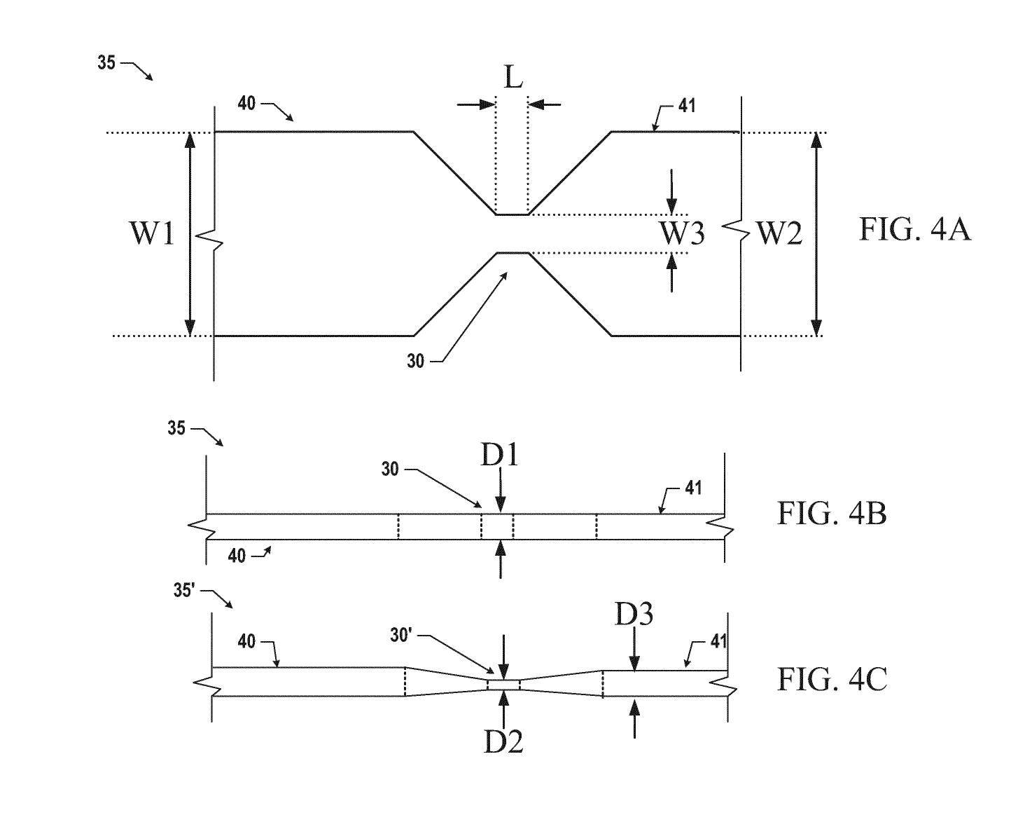

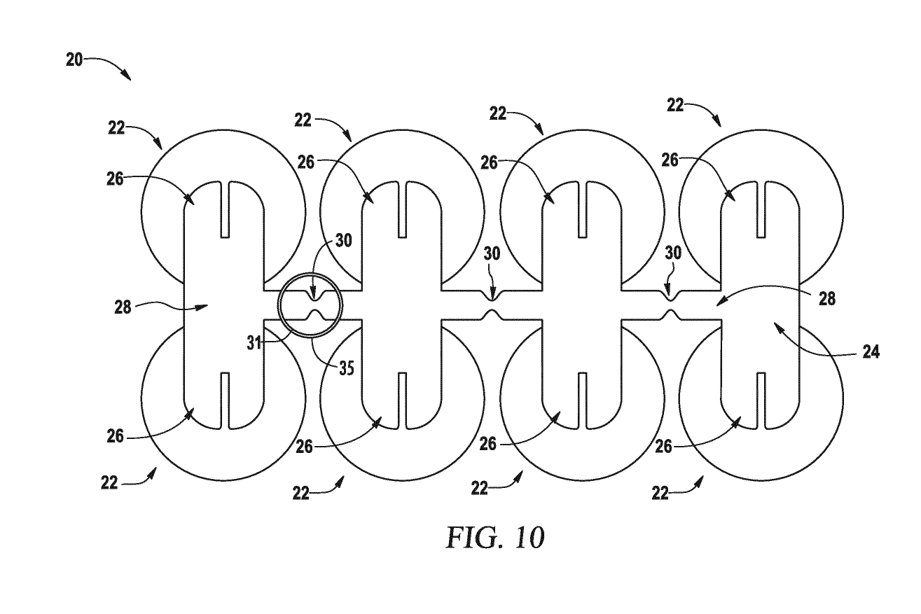

In yet some other embodiments, as exemplified by FIG. 10, fuses 30 are only located at position 31 between one or more pair of cells along the central body portion 28 so that there are no fuses at position 29 proximate to each cell 22. FIG. 10 therefore illustrates a fuse (and three in total) located between each of the four pairs of cells 22. This allows pairs of cells 22 to be serially connected with each other with fuses 30 disposed between each pair of cells 22. The fuses 30 are described below with respect to the illustration of FIGS. 4A-4C.

To illustrate the fuses 30 themselves, FIG. 4A and FIGS. 4B and 4C illustrate top and side perspective views, respectively, of a portion 35 of the cell connector 24 of FIG. 2, which includes a first body portion 40, a second body portion 41, and a fuse 30 according to some embodiments. As illustrated, the first body portion 40 and the second body portion 41 have a first width W1 and a second width W2, respectively, and narrow therebetween to a smaller third width W3 at the fuse 30. The fuse's length L and cross-sectional area A (W3×the depth D of the connector 24 at the fuse 30) are set so that the fuse 30 melts or “burns out” once the current through the fuse 30 reaches a threshold, as will be discussed more later. The cross-sectional area includes a depth D and width W3. The fuse's cross-sectional area A and length L are determined based on the type of material the fuse 30 is composed of as well as the desired current threshold and the desired burnout time for one or more current levels. More specifically, the melting time is directly proportional to the fuse's resistance R, while the fuse's resistance R is inversely proportional to the fuse's cross-sectional area A and directly proportional to the fuse's length L and material density ρ (i.e., R=ρ*L/A). For example, the fuse's cross-sectional area may range from 1.5 mm²-2 mm², the melting time may range from 3 seconds to 115 seconds, and the burnout current may range from 10 amps to 70 amps. Of course any other range for these parameters is also possible. The fuse material used may be steel, nickel, copper, various alloys, or any other material which is configured to break down at too high a current.

In addition to (or as an alternative to) narrowing the width W of the connector 24 to create the fuse 30, one may vary the depth D of the connector to create the fuse 30 and set the burn out sensitivity of the fuse 30. In some embodiments, as illustrated in the side view of an exemplary cell connector portion 35 of FIG. 4B, the depth D1 of the fuse 30 may be the same as the depth of the first and second body portions 40, 41 of the cell connector 24. In fact, in some embodiments the cell connector 24 is cut or otherwise formed from a metallic sheet having a uniform depth throughout and, thus, the depth D1 of all fuses 30 may be equal to each other and equal to the depth of the connector 24 in general. However, in other embodiments such as the illustrated embodiment of FIG. 4C, the connector's depth narrows in the area of the fuse such that depth D2 of the fuse 30 is less than the depth D3 of the first and second body portions 40, 41 of the illustrated cell connector portion 35′. Assuming that depth D2 is less than depth D1, the fuse 30′ of cell connector portion 35′ illustrated in FIG. 4C will burn out with less current than the fuse 30 of cell connector portion 35 illustrated in FIG. 4B. Regardless, by varying the length, width, and/or depth of the fuse (as well as the materials used for the fuse), the manufacturer can make the fuse more or less sensitive to thermal runaway. In this regard, as the cross-sectional area of the fuse 30 is decreased, the fuse 30 will burn out with less current and/or in a shorter amount of time. Conversely, as the cross-sectional area of the fuse 30 is increased, the fuse 30 has a higher tolerance for a greater amount of current and/or will take a longer amount of time to burn out.

It should be noted that different cross-sectional areas may be created by different shapes and dimensions and the present invention should not be limited to the illustrative examples provided herein. Furthermore, although forming the connector 24 from a single unitary piece of material may have certain benefits, other embodiments of the connector may be formed by joining a plurality of conductors and fuses together. Likewise, although a substantially-rigid planar connector having uniform thickness may have certain benefits, other embodiments of the connector may be formed into other shapes.

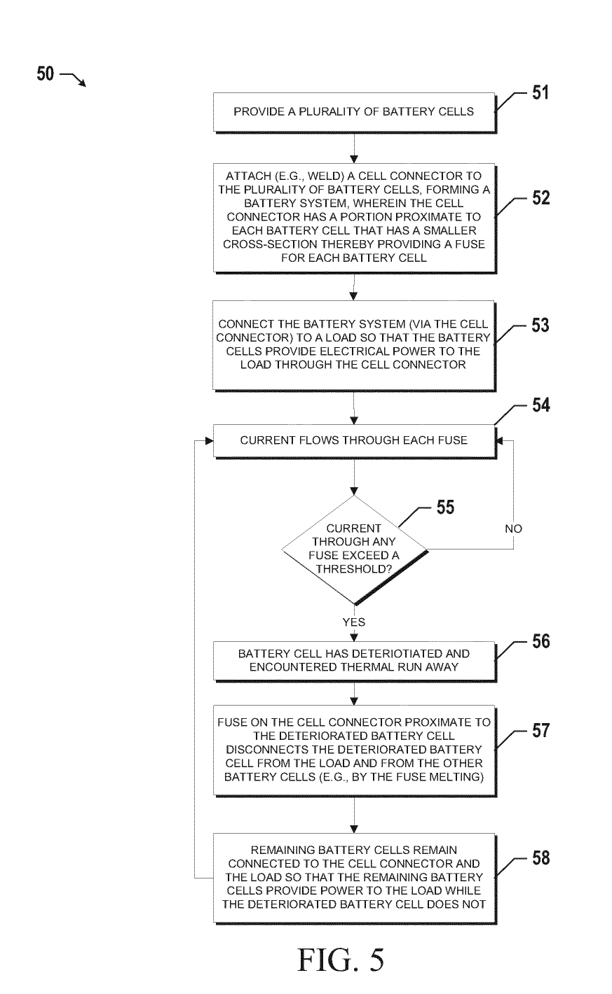

FIG. 5 illustrates a method 50 of protecting a battery system from thermal runaway according to some embodiments. In block 51, a plurality of battery cells are provided. For example, as previously presented in FIGS. 2-3, the amount of battery cells may be eight. However, any amount of battery cells may be provided.

In block 52, a cell connector as discussed herein is attached to terminals of the plurality of battery cells, thereby forming a battery system. As previously discussed, the cell connector may be connected to the battery cells by welding (or other method) the pads of the cell connector to the output terminals of the battery cells. The cell connector includes a fuse portion adjacent to each battery cell, as will be discussed later.

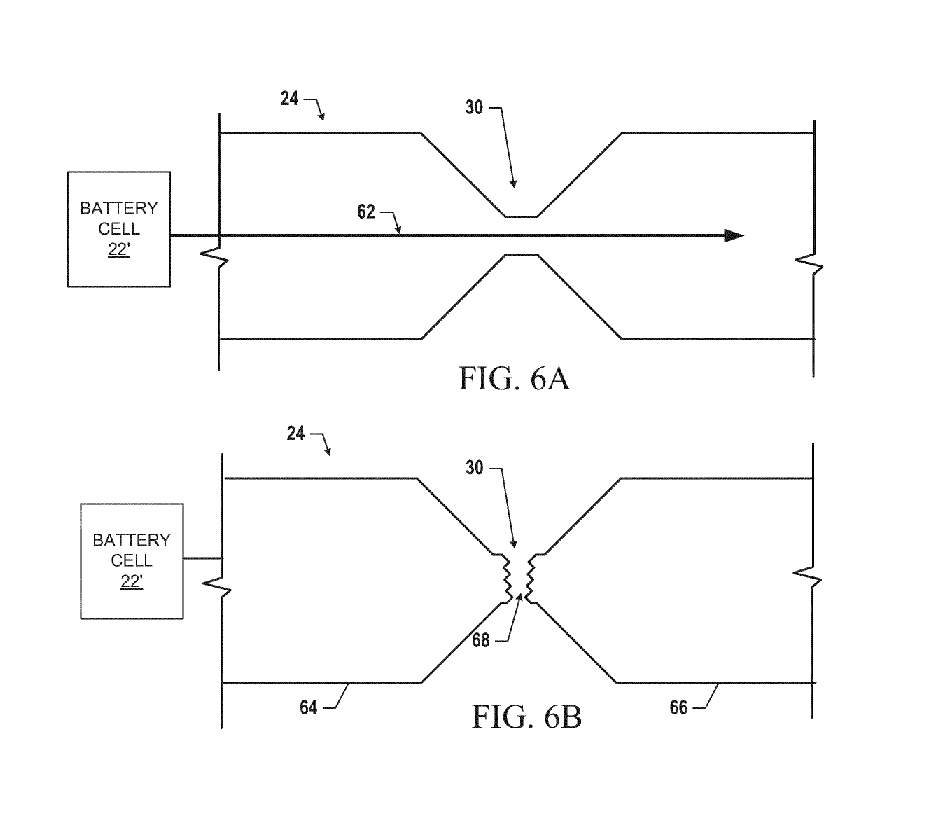

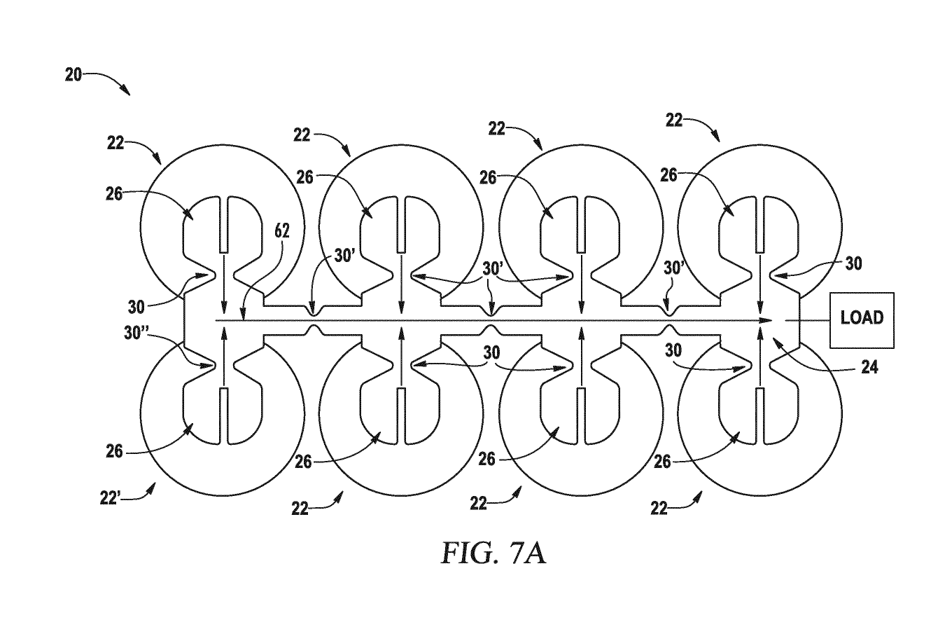

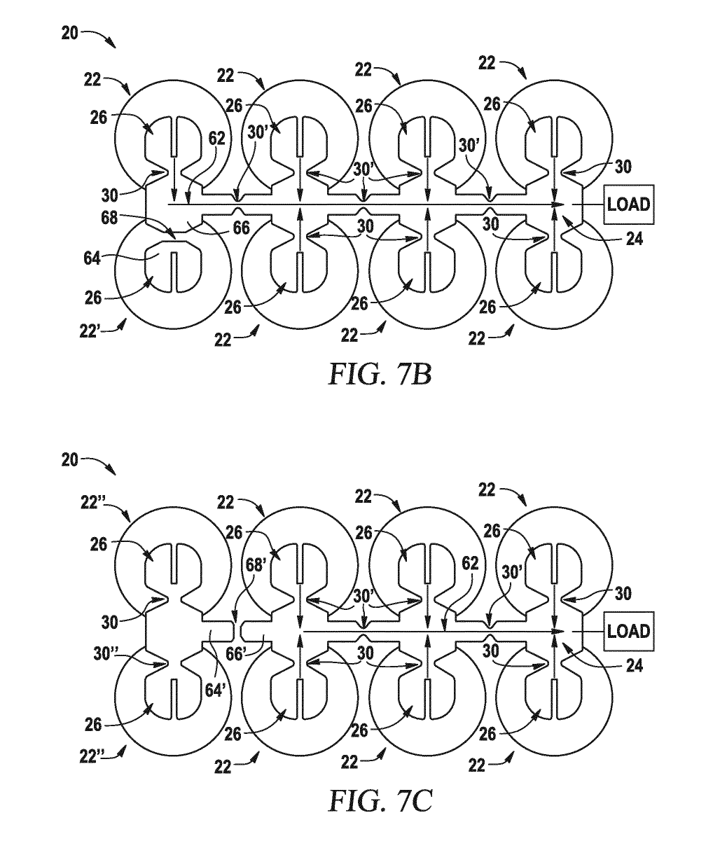

In block 53, the battery system is connected to a load so that the battery cells may provide electrical power to the load through the cell connector. In this regard, the load is connected to the cell connector so that electrical power is transmitted from each battery cell through the cell connector to the load, as is illustrated in FIGS. 6A and 7A. As such, as illustrated in FIG. 6A, current 62 flows from a battery cell 22′ through a fuse 30 of the cell connector 24. As illustrated in FIG. 7A, this occurs for each battery cell connected with the cell connector 24. Of course it will be appreciated that, although FIG. 5 refers to a situation where current is moving away from the battery cells 22 to supply power to a load, current can flow in the other direction when the battery system is attached to a charger or when a defect occurs in one or more cells. In such situations of reverse current flow, the fuses function the same way to isolate defects in the battery system.

In block 55 of FIG. 5, if the current does not exceed a threshold, the method 50 continues back to block 54 where the current 62 is allowed to continue to flow from the battery cell 22′ to the load. Otherwise, if the current 62 through the fuse 30 exceeds a threshold for a certain amount of time, the battery cell 22′ is not working properly and thermal runaway has been determined to have occurred (block 56).

In block 57, when thermal runaway occurs because the current has exceeded the threshold, the fuse 30 burns out, melts, or otherwise disconnects the battery cell 22′ from the load, as illustrated in FIGS. 6B and 7B. This occurs because the fuse 30 heats up due to a combination of internal resistance of the fuse material and the amount of current flowing through the fuse. The fuse 30 electrically disconnects the deteriorated battery cell 22′ from the load by separating a cell connector first body portion 64 that is electrically attached to the deteriorated battery cell 22′ from a cell connector second body portion 66 that is electrically connected with the load (not shown in FIGS. 6A-6B) and other battery cells (not shown in FIGS. 6A-6B). It is noted that the fuse 40 is disposed between the first and second body portions 64, 66 which have larger cross-sectional areas tapering down to smaller cross-sectional area of the fuse 30. Nonetheless, when the fuse has been broken or burned out (FIG. 6B), the first body portion 64 may still be electrically attached to the deteriorated battery cell 22′ via the cell connector pad (shown in FIG. 7B) that is connected to the deteriorated battery cell 22′. However, a space 68 is created between the first and second body portions 64, 66 creating an open circuit between the deteriorated battery cell 22′ and the load (and also the other battery cells 22). This protects the load and the other battery cells 22 from excessive current provided from the deteriorated battery cell 22′.

In block 58 of FIG. 5, the remaining battery cells 22 stay connected to the cell connector 24 and the load so that the remaining battery cells 22 continue to provide power to the load while the deteriorated battery cell 22′ does not.

As shown in FIGS. 7A-7C, each battery cell 22 has a fuse 30 proximate to each battery cell 22 that, if disconnected, would only disconnect that particular battery cell 22 from the other battery cells. For example, as illustrated in FIG. 7A, fuse 30″ is proximate to and associated with battery cell 22′ since a disconnection of fuse 30″ disconnects only battery cell 22′. In this regard, space 68 is created between the body portions 64 and 66 of the cell connector, thereby electrically disconnecting the deteriorated battery cell 22′ from the other battery cells 22 and the load, as illustrated in FIG. 7B. However, as further illustrated, current is still allowed to flow from the remaining battery cells 22 to the load even though the deteriorated battery cell 22′ has failed. It should be noted that not every battery cell requires a designed fuse 30.

In some embodiments, as illustrated in FIG. 7A, a fuse 30′ may be implemented along a central body section of the cell connector 24. This fuse 30′ is capable of disconnecting two or more battery cells 22 from the other battery cells 22. This concept is illustrated in FIG. 7C, where the centerline fuse 30′ has broken down (or burnt out) due to thermal runaway of two battery cells 22″. The burn out of fuse 30′ has created a space 68′ that produces an open circuit between the battery cells 22′ and the load. In this regard, the space 68′ physically and electrically separates a first body portion 64′ of the cell connector 24 (connected with the deteriorated battery cells 22″) with a second body portion 66′ that is electrically connected with the load.

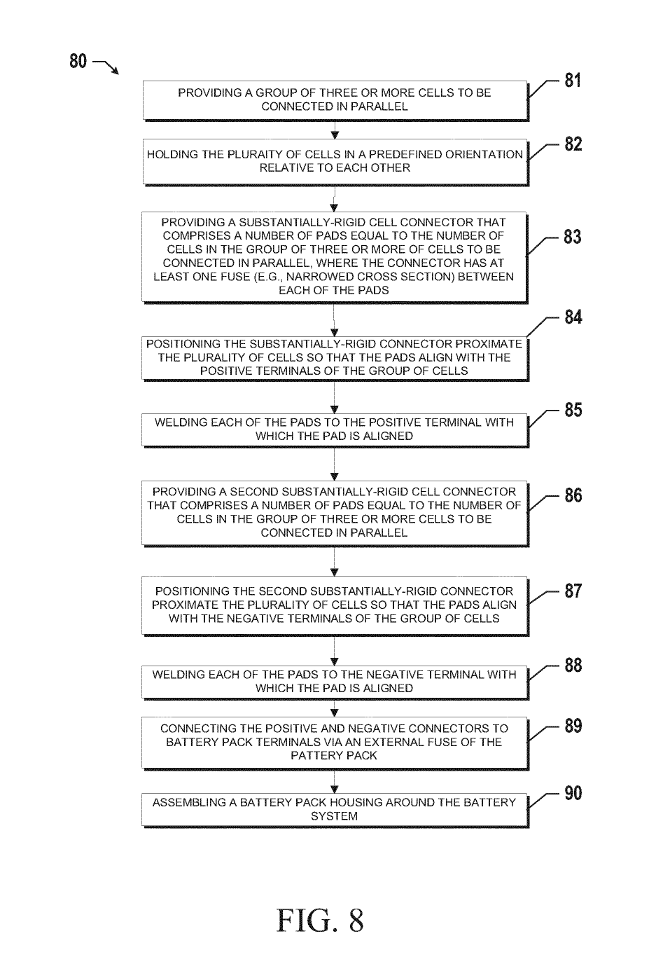

FIG. 8 illustrates a method 80 of making a battery pack in accordance with an example embodiment of the invention. It should be appreciated that some embodiments of the invention may make manufacturing a battery pack easier when several cells or groups of cells need to be connected in parallel with fuses located therebetween. In this regard, a method of manufacturing a battery pack may include providing a plurality of cells (or groups of cells) to be connected in parallel at operation 81. As described above, in some embodiments of the invention, the battery pack includes a plurality of individual cells connected in parallel using the cell connector assembly. In other embodiments, the battery pack includes a plurality of groups of cells connected in parallel using the cell connector assembly, where each group of cell includes a plurality of cells connected in series. In such embodiments, the operation 81 of providing a plurality of groups of cells may include an operation of connecting a plurality of cells in each group in series.

The method 80 may further include holding the plurality of cells or groups of cells in a predefined orientation relative to each other in operation 82. For example, in one embodiment, spacers are used to hold each cell an appropriate distance from adjacent cells and align the cells in rows and/or columns so that the positive terminals of the cells are aligned on one side of the battery system and the negative terminals are aligned on the other side of the battery system. For example, in one embodiment, to prepare the cells for the parallel connection the cells are aligned in two rows with the number of columns equal to n divided by two, where n is the number of cells to be connected in parallel by the connector.

The method 80 may further include an operation 83 of providing a substantially-rigid cell connector (such as described above) that comprises a number of pads equal to the number of cells in the group of three or more of cells to be connected in parallel, where the connector has at least one fuse (e.g., narrowed cross section) between each of the pads. This operation may include manufacturing the cell connector assemblies by, for example, stamping the structure from a metallic sheet and/or fastening individual metallic conductors together to form the structure. As recited in FIG. 8, the cell connector may be manufactured so as to be substantially-rigid at least to the point where it does not significantly lose its shape when picked up at a single point.

The method 80 may further include, in operation 84, positioning the substantially-rigid cell connector proximate the plurality of cells or groups of cells so that the plurality of pads align with positive terminals of the plurality of cells. In some embodiments, this operation is performed robotically by selecting one cell connector from a first group of cell connectors and holding it against the cells so that the pad portions of the cell connector align with the positive terminals to be connected in parallel. Here, embodiments of the invention where the cell connector is substantially-rigid may be advantageous since the cell connector will not significantly deform when picked-up and held by a robotic arm at, perhaps, a single contact point. Furthermore, if the cells are properly positioned in operation 82, then all of the pad portions of the cell connector should naturally align with the terminals when at least two pad portions are aligned with the appropriate two terminals or when any two points on the cell connector are otherwise positioned appropriately in space relative to the plurality of cells.

The method 80 may then include, in operation 85, welding (or fastening in another way) each of the pad portions of the first cell connector to the positive terminal with which each pad portion aligns. In some embodiments, the welding is completed robotically via a robotic spot welder that, now that the cell connector is held so that all of the pad portions are aligned with the appropriate terminals, can quickly spot weld all of the connections by moving to the appropriate points in space and welding the connector to the terminal down the line of the pad portions.

Operations 86, 87, and 88 are similar to operations 83, 84, and 85, but are completed for the negative terminals to be connected in parallel, and may be optional (as one or more other operations may also be optional). As such, the cell connector may be taken from a different group since, in some embodiments, the cell connector assembly for the negative terminals may be a fuse-less connector (e.g., as shown in FIG. 1) instead of the connector with the integral fuses. However, in some embodiments the connector with the fuses is used on the negative side in addition to or as an alternative to the connector with fuses being used on the positive side. In some embodiments, no connector is connected to the negative terminals and instead the negative terminals are all connected to some sort of grounding device (whether a common ground node or separate grounding points).

The method 80 may also include operation 89 where the positive and negative cell connectors are electrically connected, via an external fuse, to the positive and negative terminals of the batter pack, respectively. As illustrated by operation 90, the completed cell structure may then be disposed within a battery pack housing, where the housing makes the common output electrically assessable. For example, a positive and a negative terminal may extend from the through openings in the housing wall.

It will be appreciated that method 80 illustrates an example method of making a battery pack according to an embodiment of the invention. It should also be appreciated that other methods may also be used and that some steps in the method may be completed in a different order or simultaneously.

Thus, the cell connector, as discussed herein, may be a unitary piece of metal which has at least one internal fuse built into such piece of metal. As such, in one embodiment, no external fuse may be needed and the only fuse(s) used in the circuit are those which are integral with the cell connector as discussed herein. In another embodiment, the internal fuse of the cell connector may be used in conjunction with an external fuse to provide a backup or additional fuse(s).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. A battery system comprising:
a group of three or more battery cells; and
a connector electrically connecting the group of three of more battery cells together in parallel, the cell connector comprising a unitary conductor having at least one fuse integrally formed therein such that at least one fuse is located electrically between a first battery cell and a plurality of other battery cells in the group of three or more battery cells.

2. The battery system of claim 1, wherein the unitary conductor comprises at least two fuses integrally formed therein such that at least one fuse is located electrically between each battery cell in the group of three or more battery cells.

3. The battery system of claim 1, wherein the group of three or more battery cells comprises at least four battery cells, and wherein the at least one fuse located electrically between the first battery cell and the plurality of other battery cells is located electrically between a first plurality of cells and a second plurality of cells, the first plurality of cells comprising the first battery cell.

4. The battery system of claim 1, wherein the at least one fuse comprises a fuse portion and wherein the unitary conductor comprises:
a first body portion comprising a first cross-sectional area;
a second body portion comprising a second cross-sectional area;
the fuse portion disposed between the first and second body portions and comprising a third cross-sectional area which is less than the first cross-sectional area and less than the second cross-sectional area, the third cross-sectional area being dimensioned so as to disconnect the first body portion from the second body portion when a current traveling to or form one of the group of three of more battery cells reaches a threshold.

5. The battery system of claim 4, wherein the first body portion is connected to a first one or more battery cells and the second body portion is connected to a second one or more battery cells such that when the fuse portion disconnects the first body portion from the second body portion, the first one or more battery cells are electrically disconnected from the second one or more battery cells.

6. The battery system of claim 5, wherein the second body portion is further connected to a load such that when the fuse disconnects the first and second body portions, the second one or more battery cells remains electrically connected with the load.

7. The battery system of claim 1, wherein the unitary conductor comprises a single piece of metallic material.

8. The battery system of claim 1, wherein the unitary conductor comprises:
three or more pad portions corresponding with the three or more battery cells such that each pad portion is fastened to a terminal of one battery cell in the group of three or more battery cells;
a central portion electrically coupled to a common battery terminal; and
three or more fuse portions integrally formed with the central portion and the three or more pad portions, wherein each of the three or more fuse portions is located between one of the three or more pad portions and the central portion and comprises a smaller cross section than the pad portions and the central portion so as to form fuses located electrically between each battery cell in the group of three or more battery cells.

9. The battery system of claim 8, wherein each of the three or more fuse portions is located proximate to a different pad portion so that each fuse disconnects only the battery cell attached to the respective pad.

10. The battery system of claim 8, wherein the three or more battery cells comprises a first pair of cells and a second pair of cells, and wherein the central portion comprises a first fuse between the first pair of cells and the second pair of cells so that when the first fuse is broken the first pair of cells are electrically disconnected from the second pair of cells.

11. The battery system of claim 1, wherein the three or more battery cells comprises:
a first pair of cells;
a second pair of cells; and
a third pair of cells;
wherein the at least one fuse comprises:
a first fuse disposed between the first and second pairs of cells so as to disconnect the first pair of cells from the second set of cells when the first fuse is broken; and
a second fuse disposed between the third pair of cells and the second pairs of cells so as to disconnect the first and second pair of cells from the third set of cells when the second fuse is broken.

12. The battery system of claim 1, further comprising an external fuse disposed between a common battery terminal and the central portion.

13. The battery system of claim 1, wherein the unitary conductor comprises a plate that has a uniform thickness, and wherein only the width of the unitary conductor narrows to reduce a cross-sectional area of the at least one fuse.

14. A cell connector configured for attachment to a plurality of battery cells, the cell connector comprising:
a body;
a first pad configured to connect to a first battery cell of the plurality of battery cells to the body;
a second pad configured to connect to a second battery cell of the plurality of battery cells to the body;
a third pad configured to connect to a third battery cell of the plurality of battery cells to the body; and
a first fuse portion being shaped and dimensioned to break down when the first battery cell outputs a defined amount of current, thereby disconnecting the first battery cell from at least one other battery cell.

15. The cell connector of claim 14 further comprising:
a second fuse portion being shaped and dimensioned to break down when the second battery cell outputs a defined amount of current, thereby disconnecting the second battery cell from at least one other battery cell; and
a third fuse portion being shaped and dimensioned to break down when the third battery cell outputs a defined amount of current, thereby disconnecting the third battery cell from at least one other battery cell.

16. The cell connector of claim 15, wherein the body, the first pad, the second pad, the third pad, the first fuse portion, the second fuse portion, and the third fuse portion are integrally formed as a single piece of conductive material.

17. The cell connector of claim 15, wherein the first fuse portion is configured to disconnect only the first battery cell from the other battery cells and any load connected to the cell connector, wherein the second fuse portion is configured to disconnect only the second battery cell from the other battery cells and any load connected to the cell connector, and
wherein the third fuse portion is configured to disconnect only the third battery cell from the other battery cells and any load connected to the cell connector.

18. The cell connector of claims 14, further comprising:
a fourth pad configured to connect to a fourth battery cell of the plurality of battery cells to the body, and
wherein the first fuse portion is shaped and dimensioned to break down when either the first battery cell or the fourth battery cell outputs a defined amount of current, thereby disconnecting the first battery cell and the fourth battery cell from the second battery cell and the third battery cell.

19. A method of manufacturing a battery pack where a plurality of cells are to be connected in parallel and each of the plurality of cells is to be connected to a common output via a current path, the method comprising:
providing a group of three or more battery cells;
providing a connector, the connector electrically connecting the group of three of more battery cells together in parallel, the connector comprising a unitary conductor comprising at least two fuses integrally formed therein such that at least one fuse is located electrically between at least two battery cells in the group of three or more battery cells, wherein the connector defines the current path between the common output and each of the battery cells, and wherein the connector comprises a conductor arranged in a structure configured to electrically couple to the common output at a first end portion and to a terminal of each of the plurality of cells at each of a plurality of second end portions;
positioning the connector proximate the group of three or more battery cells so that each of the plurality of second end portions aligns with a terminal of a cell; and
fastening each of the plurality of second end portions to the terminal with which it aligns to facilitate parallel connection of the plurality of cells within the battery pack.

20. (canceled)

21. The method of claim 19, wherein a first fuse of the at least two fuses is disposed between a first pair of battery cells and a second pair of battery cells so that when the fuse breaks down due to current the first pair of battery cells is electrically isolated and disconnected from the second pair of battery cells.

22. (canceled)

23. (canceled)
